(19) United States
(12) Patent Application Publication
(10) Pub. No.: US 2026/0320908 A1
(43) Pub. Date: Oct. 15, 2026

(54) GENERATING THREE-DIMENSIONAL REPRESENTATION OF OBJECT BASED ON PROMPT

(71) Applicant: GOOGLE LLC, Mountain View, CA (US)

(72) Inventors: Alberto García García, Gattikon (CH); Stylianos Moschoglou, London (GB); Sergio Orts Escolano, Zurich (CH); Marie-Julie Rakotosaona, Zurich (CH); Leonhard Helminger, Zurich (CH); Sonia Laguna Cillero, Zurich (CH)

(21) Appl. No.: 19/644,373

(22) Filed: Apr. 10, 2026

Related U.S. Application Data
(60) Provisional application No. 63/786,772, filed on Apr. 10, 2025.

(51) Int. Cl. G06T 15/20; G06T 7/194; G06T 17/20

(52) U.S. Cl. CPC G06T 15/205; G06T 7/194; G06T 17/20; G06T 2207/20076; G06T 2207/30244

(57) ABSTRACT

A computer-implemented method includes generating a first two-dimensional image of an object based on a prompt describing the object, and a transformation of a first representation of the object based on a probability of a first feature being included in the first two-dimensional image of the object, the probability of the first feature being based on the first representation of the object and at least two sample two-dimensional images; generating a second two-dimensional image of the object from a different perspective than the first two-dimensional image of the object by transforming a second representation of the object based on the first two-dimensional image and a probability of a second feature being included in the second two-dimensional image of the object; and generating a three-dimensional representation of the object based on the first two-dimensional image of the object and the second two-dimensional image of the object.

### CROSS-REFERENCE TO RELATED APPLICATION

This application claims priority to U.S. Provisional Application No. 63/786,772, filed on Apr. 10, 2025, the disclosure of which is hereby incorporated by reference.

### BACKGROUND

Synthetic data has become a cornerstone in the training and development of machine learning models, particularly for perception tasks in computer vision. Applications spanning autonomous navigation, indoor scene understanding, and robotic interaction rely on vast amounts of high-quality, annotated training data that reflects real-world complexity.

In the context of scene understanding, synthetic three-dimensional indoor environments play a role in training perception models. Realistic room layouts populated with diverse and customizable assets provide training grounds for perception tasks such as depth estimation, object segmentation, and scene reconstruction.

### SUMMARY

A three-dimensional mesh representation of an object is generated from a text prompt. This process allows a user to describe a physical item in plain language and receive a fully-realized three-dimensional digital model that can be rotated and viewed from any angle. To achieve this, a high-quality two-dimensional image is created based on the user's description. From that single image, images from different views, such as the back, sides, top, and bottom, are generated ensuring that all these views are consistent with each other. Finally, these different perspectives are combined to build a digital three-dimensional structure made of points, lines, and surfaces. This enables the rapid creation of digital items.

According to an example, a computer-implemented method includes generating a first two-dimensional image of an object based on a prompt describing the object, and a transformation of a first representation of the object based on a probability of a first feature being included in the first two-dimensional image of the object, the probability of the first feature being based on the first representation of the object and at least two sample two-dimensional images; generating a second two-dimensional image of the object from a different perspective than the first two-dimensional image of the object by transforming a second representation of the object based on the first two-dimensional image and a probability of a second feature being included in the second two-dimensional image of the object; and generating a three-dimensional representation of the object based on the first two-dimensional image of the object and the second two-dimensional image of the object.

According to an example, a non-transitory computer-readable storage medium includes instructions stored thereon. When executed by at least one processor, the instructions are configured to cause a computing system to generate a first two-dimensional image of an object based on a prompt describing the object, and a transformation of a first representation of the object based on a probability of a first feature being included in the first two-dimensional image of the object, the probability of the first feature being based on the first representation of the object and at least two sample two-dimensional images; generate a second two-dimensional image of the object from a different perspective than the first two-dimensional image of the object by transforming a second representation of the object based on the first two-dimensional image and a probability of a second feature being included in the second two-dimensional image of the object; and generate a three-dimensional representation of the object based on the first two-dimensional image of the object and the second two-dimensional image of the object.

A computing system includes at least one processor and a non-transitory computer-readable storage medium including instructions stored thereon. When executed by at the least one processor, the instructions are configured to cause the computing system to generate a first two-dimensional image of an object based on a prompt describing the object, and a transformation of a first representation of the object based on a probability of a first feature being included in the first two-dimensional image of the object, the probability of the first feature being based on the first representation of the object and at least two sample two-dimensional images; generate a second two-dimensional image of the object from a different perspective than the first two-dimensional image of the object by transforming a second representation of the object based on the first two-dimensional image and a probability of a second feature being included in the second two-dimensional image of the object; and generate a three-dimensional representation of the object based on the first two-dimensional image of the object and the second two-dimensional image of the object.

The foregoing general description of the illustrative embodiments and the following detailed description thereof are merely exemplary aspects of the teachings of this disclosure and are not restrictive.

### BRIEF DESCRIPTION OF THE DRAWINGS

FIG. 1 is a pipeline for generating a three-dimensional mesh representation of an object from a text prompt.

FIG. 2 is a block diagram of a computing system for generating the three-dimensional mesh representation.

FIG. 3 is another pipeline for generating a three-dimensional mesh representation of an object from a text prompt.

FIG. 4 is a flowchart of a method for generating text prompts for synthetic three-dimensional object generation.

FIG. 5 is a flowchart of a method performed by the computing system.

### DETAILED DESCRIPTION

This disclosure provides a technical solution for the automated synthesis of three-dimensional assets by linking semantic text prompts to a two-stage diffusion pipeline. By first generating a high-fidelity 'anchor' image (two-dimensional image) and subsequently expanding that image into a set of pose-conditioned, geometrically consistent views (multiple two-dimensional views), dense volumetric data can be constructed. This data is then distilled into a three-dimensional representation such as a standard mesh format (three-dimensional mesh representation), allowing for the rapid, scalable generation of diverse synthetic objects for use in training computer vision models and populating virtual environments.

Within synthetic three-dimensional indoor environments by simulating variations in object type, color, placement, and material properties, synthetic data can bridge domain gaps that arise from the limited variability of real-world datasets. As demand for photorealistic three-dimensional content grows, high-quality meshes remain useful for immersive and interactive experiences. This deepens the interest in synthetic data in the form of three-dimensional meshes. However, generating complete meshes of three-dimensional scenes remains a challenge. A technical problem with mesh generation approaches is difficulty with producing detailed meshes in complex scenes and maintaining consistent performance across diverse object categories. Mesh generation approaches have technical problems with global consistency, geometry fidelity, and artifact-free outputs.

A technical solution to this technical problem is an end-to-end system for synthetic data generation for scalable, high-quality, and customizable three-dimensional objects that can be added to indoor scenes. By integrating and adapting text-to-image and transformation models (such as iterative transformation models including multi-view diffusion models), this system generates objects as three-dimensional mesh representations from text prompts and incorporates the three-dimensional objects into predefined floor plans. This technical solution has the technical benefit of on-demand scene generation with global consistency, geometry fidelity, and artifact-free outputs.

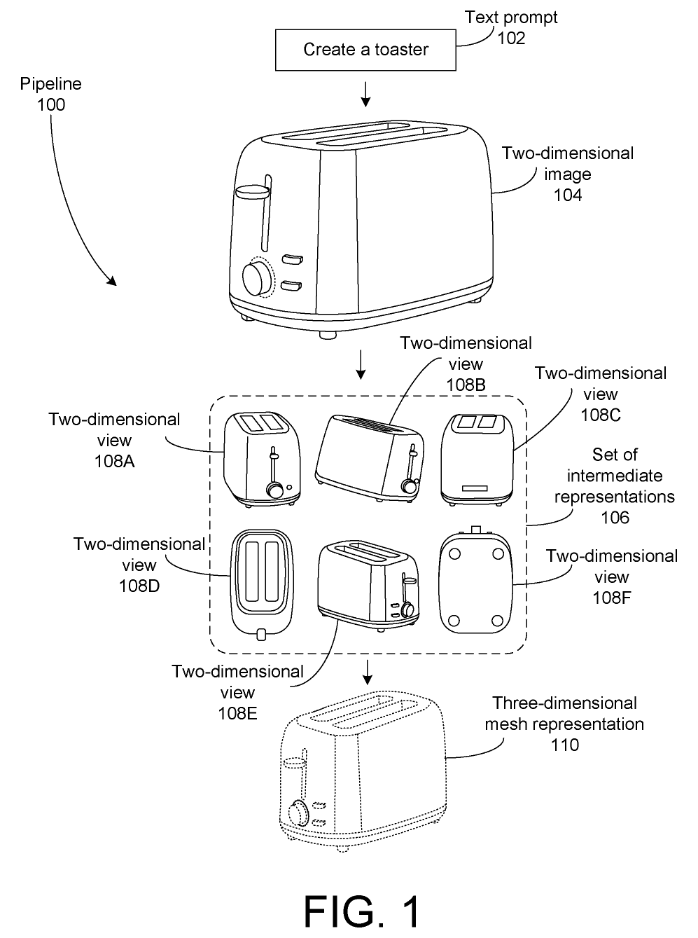

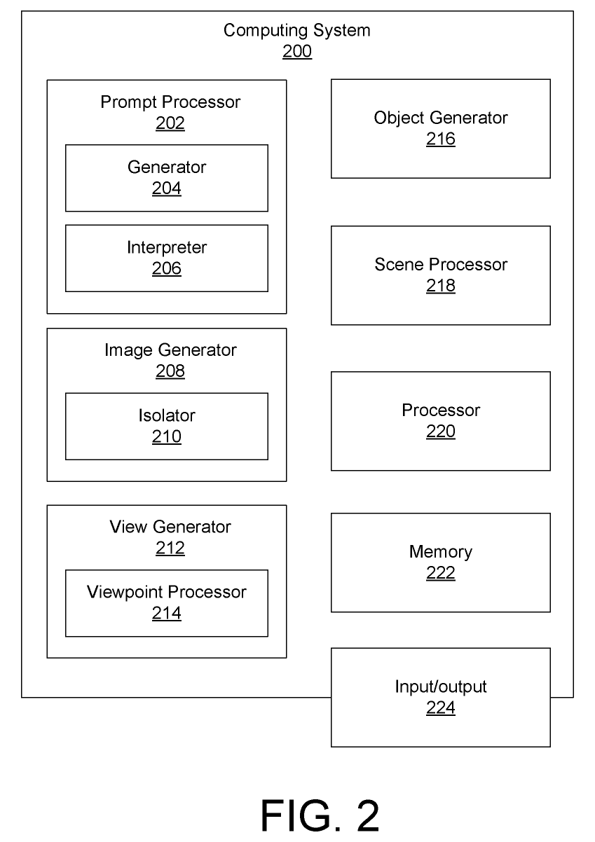

FIG. 1 is a pipeline 100 for generating a three-dimensional mesh representation 110 of an object from a text prompt 102. The pipeline 100 can be implemented in a computing system such as the computing system 200 described with respect to FIG. 2.

The pipeline 100 can receive the text prompt 102. The text prompt 102 is an example of the prompt that the pipeline 100 can receive. A text prompt is a machine-readable natural language string comprising one or more semantic descriptors that define the visual and structural attributes of an object to be synthesized. In some implementations, the pipeline 100 receives the text prompt 102 from a user, such as via keyboard input or voice transcription. In some implementations, the text prompt 102 is generated by the computing system that implements the pipeline 100 or a computing system in communication with the computing system that implements the pipeline 100. In the example shown in FIG. 1, the text prompt 102 is, "Create a toaster."

The pipeline 100 responds to the text prompt 102 by creating a two-dimensional image 104. The two-dimensional image 104 is a two-dimensional image of an object that is based on the text prompt 102. A two-dimensional image is a digital array of pixels representing a single-view visual projection of an object, encoded with semantic and spatial features derived from a textual description. An object is a discrete three-dimensional digital entity representing a physical item, characterized by a defined surface geometry and a set of visual or material attributes derived from a textual description. The pipeline 100 can identify the object based on the text prompt 102. The text prompt 102 describes the object identified by the pipeline 100. The two-dimensional image 104 is an example of a first two-dimensional image of the object.

The pipeline creates the two-dimensional image 104 by iteratively transforming a set of intermediate representations of the object that was described by the prompt 102. Iteratively transforming can include a multi-step computational process wherein a data representation is repeatedly modified by a neural network to progressively reduce noise or error until the representation converges toward a target state. Intermediate representations can be considered a sequence of evolving data states that transition into final states of structured data. The set of intermediate representations of the object can be considered a first set of intermediate representations of the object. In some implementations, iteratively transforming the first set of intermediate representations of the object includes generating the two-dimensional image 104 from the text prompt 102 by a text-to-image diffusion process. The text-to-image diffusion process is an example of iteratively transforming the first set of intermediate representations of the object. The first set of intermediate representations of the object may initially comprise noise or random values. At each iteration, the diffusion process refines the intermediate representations to progressively reduce noise and increase fidelity to the object described by the text prompt 102. The iterative transformation continues until the intermediate representations converge to a two-dimensional image 104 that depicts the object described by the text prompt 102.

In some implementations, the pipeline 100 generates the two-dimensional image 104 by transforming a first representation of the object based on a probability of a first feature being included in the two-dimensional image 104 of the object. A feature can be a discrete pixel arrangement within a two-dimensional image. In some implementations, a feature can be a discrete arrangement of pixel intensities within a two-dimensional image. In some implementations, a feature can be a discrete pixel arrangement within a two-dimensional image that is sampled from a learned probability distribution. In some implementations, a feature can be a discrete pixel arrangement within a two-dimensional image that is iteratively refined. In some implementations, a feature can be a discrete spatial arrangement of pixel intensities within a two-dimensional image that is sampled from a learned probability distribution and iteratively refined, such as through the addition or replacement of noise during a diffusion process. A feature can be analogous to a character or word being selected in a Markov chain that uses a corpus of two-dimensional images to determine transition probabilities. The probability of the first feature can be based on the first representation of the object and at least two sample two-dimensional images. The probability of the first feature can be based on the first representation of the object and at least two sample two-dimensional images. The at least two sample two-dimensional images can be a dataset of images used to train a model that generates the two-dimensional image 104. The transformation of the first representation of the object based on the probability can be characterized by a Markov Chain, in which a reverse process progressively refines the first representation from noise toward a target state. In the Markov Chain, each step of the reverse process generates a next state based on a current state and a learned probability distribution, where the learned probability distribution is learned from the at least two sample two-dimensional images. The probability of the feature being included in the two-dimensional image of the object can be implemented by a diffusion process.

In some implementations, the text prompt 102 includes contextual phrases specifying a position of the object (such as "in an empty white background" and "in the middle") to improve spatial clarity and prevent issues like object cropping or awkward placements. A contextual phrase can be considered a textual descriptor within a text prompt that provides non-categorical constraints regarding the environmental or spatial properties of a target object. These contextual phrases may ensure that the generated two-dimensional image 104 aligns with the requirements of subsequent stages of the pipeline 100.

In some implementations, the pipeline 100 applies semantic segmentation on the two-dimensional image 104 to isolate the object from a background and ensure a smooth, homogeneous background for the object. The pipeline 100 can add padding around the isolated object to generate an isolated two-dimensional image. The isolated two-dimensional image is an example of the first two-dimensional image of the object after segmentation.

After generating the two-dimensional image 104, the pipeline 100 generates multiple two-dimensional views 108A, 108B, 108C, 108D, 108E, 108F of the object based on the two-dimensional image 104. Two-dimensional views can be considered digital images representing the same object from different spatial orientations, where the visual features of the object maintain a singular three-dimensional topology. The pipeline 100 generates multiple two-dimensional views 108A, 108B, 108C, 108D, 108E, 108F of the object by iteratively transforming a set of intermediate representations 106 of the object based on the two-dimensional image 104 and a plurality of camera poses. A camera pose can include a combination of the three-dimensional coordinates (translation) and the angular orientation (rotation) of a virtual or physical camera relative to a target object's coordinate system. The set of intermediate representations 106 of the object can be considered a second set of intermediate representations of the object. The plurality of camera poses can be different camera poses or angles from which images of the object would be captured. The multiple two-dimensional views 108A, 108B, 108C, 108D, 108E, 108F of the object can be geometrically consistent with each other, so that the multiple two-dimensional views 108A, 108B, 108C, 108D, 108E, 108F of the object appear similar to images of a three-dimensional version of the object that were captured by a camera from different angles. Geometrical consistency can include to a mathematical synchronization of object features across a plurality of two-dimensional views, such that the views satisfy epipolar constraints derived from their respective camera poses to represent a singular three-dimensional topology. Each of the multiple two-dimensional views 108A, 108B, 108C, 108D, 108E, 108F is an example of a second two-dimensional image of the object generated from a different perspective than the first two-dimensional image. The set of intermediate representations 106 includes examples (two-dimensional views 108A, 108B, 108C, 108D, 108E, 108F) of a second representation of the object. The pipeline 100 transforms the second representation of the object based on the first two-dimensional image and a probability of a feature being included in the second two-dimensional image of the object.

In some implementations, the pipeline 100 generates the multiple two-dimensional views 108A, 108B, 108C, 108D, 108E, 108F by transforming a second representation of the object based on the first two-dimensional image 104 and a probability of a second feature being included in a second two-dimensional image of the object. The two-dimensional views 108A, 108B, 108C, 108D, 108E, 108F are examples of the second two-dimensional image of the object. The transformation of the second representation can also be characterized by a Markov Chain.

In some implementations, the probability of the second feature being included in the second two-dimensional image of the object is based on a first three-dimensional representation of the object. The first three-dimensional representation of the object can be a three-dimensional volume constructed from vertices that are projected onto the second two-dimensional images to obtain features. The features from each second two-dimensional image can be extracted and concatenated to form a spatial feature volume. The spatial feature volume enforces a global constraint that all second two-dimensional images are views of the same object, thereby achieving geometrical consistency across the second two-dimensional images. The three-dimensional mesh representation 110 can be considered a second three-dimensional representation of the object that is generated based on the geometrically consistent second two-dimensional images.

In some implementations, the pipeline 100 generates the multiple two-dimensional views 108A, 108B, 108C, 108D, 108E, 108F by applying a multi-view diffusion process. The multi-view diffusion process is an example of transforming a second representation of the object based on the first two-dimensional image 104 and a probability of a second feature being included in a second two-dimensional image of the object. The multi-view diffusion process is an example of generating the multiple two-dimensional views 108A, 108B, 108C, 108D, 108E, 108F by iteratively transforming the set of intermediate representations 106.

The multi-view diffusion process generates multiple images of a single two-dimensional image (such as the multiple two-dimensional views 108A, 108B, 108C, 108D, 108E, 108F) of an object as if the object was viewed from different angles, as if photographs of the object were taken from the front, back, sides, top, and bottom of the object. The multi-view diffusion process starts with the original two-dimensional image and a set of desired camera positions (or camera poses, which are the angles from which the other views of the object will be generated). Each new view of the object is gradually built up through many small refinement steps. At each refinement step, the pipeline 100 improves an understanding of what the object would look like from each new angle, ensuring that all the generated views are consistent with each other—meaning they all look as if they are images of the same three-dimensional object. The pipeline 100 applies learned patterns from a large number of images to determine how to generate unseen portions of the object. the multi-view diffusion process achieves geometrical consistency of the multiple images by considering all the views together during generation of the multiple views.

The multi-view diffusion process can include latent representation encoding. Latent representations are compressed, encoded versions of images that capture information about an object in a more compact form. When the pipeline 100 processes the two-dimensional image 104 of the object, the pipeline 100 can first convert the two-dimensional image 104 into a latent representation using an encoder (such as a variational auto-encoder). Because latent representations are smaller and more compact than full images, the pipeline 100 can process latent representations more efficiently than the full images. The latent representations also capture the meaningful structure of the object—its shape, features, and spatial relationships—in a form that makes the latent representations more efficient to perform operations on , such as determining what the object would look like from different angles. During the multi-view diffusion process, the pipeline 100 can iteratively transform these latent representations, gradually refining the latent representations until the latent representations can be decoded back into full two-dimensional images showing the object from multiple viewpoints. The latent space acts as an intermediate workspace where the pipeline 100 can manipulate and generate new views of the object before converting the new views back into visible images.

The pipeline 100 can implement the latent representation encoding by applying a variational auto-encoder (VAE) to transform input images into a latent space to capture spatial and semantic features of the object. A VAE is a type of neural network that learns to compress images into a smaller, more compact form and then reconstruct the images back into full images. A VAE includes an encoder and a decoder. The encoder takes an input image and compresses the input image into a smaller representation. This compressed form of the image can be called a latent representation. The decoder performs the reverse of the encoder-the decoder expands the compressed latent representation back into a full image. The "variational" aspect of the VAE means that the VAE learns a range of possible compressed representations of each image, which helps the VAE generate new, slightly different versions of images and handle uncertainty about what an object would look like from angles that were not directly observed. In the context of the pipeline 100, the VAE transforms the two-dimensional image 104 into a latent representation that can be efficiently processed and manipulated to generate the multiple two-dimensional views 108A, 108B, 108C, 108D, 108E, 108F from different camera poses.

The multi-view diffusion process can include pose-conditioned diffusion where the representation of the object is conditioned on camera poses corresponding to observed and target viewpoints. Pose-conditioned diffusion is an image-generation processthat is guided by information about camera positions and angles. When generating multiple views of the object, the pipeline 100 needs to know where each "virtual camera" is positioned relative to the object. A camera pose describes both the location of the camera (where the camera is in three-dimensional space) and the orientation of the camera (which direction the camera is pointing). For example, one camera pose could represent looking at a toaster from the front, while another represents looking at it from above. In pose-conditioned diffusion, this camera pose information is fed into the diffusion process alongside the image data. The pipeline 100 uses the camera pose to understand what portion of the object should be visible in each generated view and how the object should appear from that particular angle. For instance, if the camera pose indicates a view from behind the toaster, the pipeline 100 generates an image showing the back panel rather than the front controls. The "conditioning" constrains or guides the output based on the camera pose. Rather than generating random views, the diffusion process is steered to produce views that match the specified camera positions. This ensures that each generated view corresponds to a specific, known viewpoint, which is beneficial for later combining the views into an accurate three-dimensional representation. In the context of the pipeline 100, pose-conditioned diffusion helps generate the multiple two-dimensional views 108A, 108B, 108C, 108D, 108E, 108F that are geometrically consistent with each other and correspond to the specified camera poses. The camera poses are examples of at least two camera poses, where a first of the at least two camera poses corresponds to the first two-dimensional image and a second of the at least two camera poses corresponds to the second two-dimensional image.

The multi-view diffusion process can include progressive view synthesis where the pipeline 100 generates multiple target views (camera poses) by iteratively refining the intermediate representations into high-fidelity projections. Consistency across synthesized views improves subsequent reconstruction of the three-dimensional representation of the object. The multi-view diffusion process may incorporate three-dimensional self-attention layers and binary masks to indicate observed inputs, addressing sparse input scenarios. Strategic anchor views may be selected using an autoregressive sampling strategy. To scale to dense viewpoints, the pipeline 100 may cluster proximal camera positions and leverage anchor views to maintain coherence across target viewpoints. The multi-view diffusion process ensures geometrical consistency across views for accurate three-dimensional reconstruction. The multi-view diffusion process achieves geometrical consistency by applying a cross-view attention mechanism during each iteration of the transformation. The cross-view attention mechanism correlates features at specific spatial coordinates in a first view with corresponding epipolar lines in a plurality of secondary views. By enforcing these geometric constraints within the latent space, the pipeline 100 ensures that the appearance and position of object features are mathematically synchronized across all generated viewpoints, preventing 'drift' from occurring in the image generation process. In some implementations, the multi-view diffusion process is fine-tuned with high-quality single object datasets to avoid background speckles or inconsistencies. In some implementations, the multi-view diffusion process applies LPIPS perceptual loss to preserve semantic integrity, such as when generating views from angles with limited information from the original two-dimensional image 104.

In some implementations, the multi-view diffusion process is fine-tuned with high-quality single object datasets to avoid background speckles or inconsistencies. The fine-tuning process can utilize a combination of a reconstruction loss to ensure pixel-level accuracy and a LPIPS perceptual loss to preserve semantic integrity, particularly when generating views from angles with limited information from the original two-dimensional image 104. Furthermore, a geometry-aware loss is applied to penalize deviations from a predicted mean shape, ensuring that the synthesized views can be successfully converged into a stable volumetric representation.

The multi-view diffusion process has at least one technical benefit of improving global consistency by generating all views of the object together rather than independently. By considering all views concurrently during the diffusion process, the pipeline 100 can ensure that features visible in one view are consistent with features visible in other views. For example, if a handle appears on the left side of an object in a front view, the multi-view diffusion process can ensure that the same handle appears in the equivalent position in side and rear views. The three-dimensional self-attention layers may enable the model to reason about the three-dimensional structure of the object across all views, maintaining global consistency even for complex objects with intricate details.

The pipeline 100 can generate the three-dimensional mesh representation 110 of the object by generating a set of three-dimensional points based on the multiple two-dimensional views 108A, 108B, 108C, 108D, 108E, 108F and the camera poses. A three-dimensional mesh representation is a digital model of an object comprising a collection of vertices, edges, and faces that define the polyhedral shape and surface geometry of the object in a three-dimensional coordinate system. The three-dimensional mesh representation is an example of a three-dimensional representation of the object. The three-dimensional mesh representation can be considered a second three-dimensional representation of the object.

In some implementations, the pipeline 100 generates the three-dimensional mesh representation 110 by applying a Neural Radiance Field (NeRF) transformation to the multiple two-dimensional views 108A, 108B, 108C, 108D, 108E, 108F and the camera poses. NeRFs transform multi-view two-dimensional projections into detailed three-dimensional scene representations. NeRFs are neural network-based models that generate high-quality three-dimensional scenes from two-dimensional images by learning to represent volumetric density and view-dependent color at any three-dimensional point. The NeRF learns to predict, for any point in three-dimensional space, how dense that point is (whether the point is part of the object or empty space) and what color that point would appear when viewed from any direction. By querying many points throughout the space around the object, the pipeline 100 generates a volumetric representation. The volumetric representation is an example of a first three-dimensional representation of the object. The volumetric representation can be considered a three-dimensional cloud of points with associated density and color values. The volumetric representation captures the shape and appearance of the object from the information contained in the multiple two-dimensional views.

The NeRF transformation is an example of generating the set of three-dimensional points based on the multiple two-dimensional views 108A, 108B, 108C, 108D, 108E, 108F and the camera poses. The NeRF learns to predict, for any point in three-dimensional space, how dense that point is (whether the point is part of the object or empty space) and what color that point would appear when viewed from any direction. By querying many points throughout the space around the object, the pipeline 100 builds the three-dimensional mesh representation 110 from the volumetric representation.

In some implementations, the pipeline 100 applies enhancements to the NeRF transformation to improve geometrical consistency. The enhancements can include density regularization for better geometrical consistency by including a logarithmic sparsity loss on the output densities, normal smoothness and orientation losses to improve surface quality, and estimated normal supervision by leveraging a monocular depth estimation model, which uses the estimated depth to compute gradients and use them as view-corresponding normals to regularize the geometry, as non-limiting examples.

The enhancements to the NeRF transformation have at least one technical benefit of improving geometry fidelity. The density regularization with logarithmic sparsity loss can encourage the NeRF to produce clean, well-defined surfaces rather than diffuse or noisy density fields. The normal smoothness and orientation losses can ensure that surface normals are consistent and smooth, resulting in surfaces that are geometrically consistent and free of artifacts. The estimated normal supervision from the monocular depth estimation model may provide additional geometric constraints that improve the accuracy of the reconstructed surface geometry, particularly in regions where the multi-view information may be sparse or ambiguous.

In some implementations, after generating the volumetric representation using the NeRF, the pipeline 100 extracts the three-dimensional mesh representation 110 from the volumetric representation using NeRFMeshing. NeRFMeshing extracts geometrically accurate three-dimensional meshes, such as the three-dimensional mesh representation 110, from NeRFs, enabling integration into standard computer graphics and simulation pipelines. NeRFMeshing can distill the volumetric representation into a compact mesh format. The pipeline 100 can add the three-dimensional mesh representation 110 to a preexisting three-dimensional scene.

NeRFMeshing has at least one technical benefit of providing artifact-free outputs by applying a Signed Surface Approximation Network (SSAN) to extract clean, geometrically accurate meshes from the volumetric NeRF representation. The SSAN can identify the precise boundary between the object and empty space, producing meshes with well-defined surfaces and edges. Additional SSIM and LPIPS supervision during mesh extraction can ensure that the extracted mesh produces rendered views that are both structurally and perceptually similar to the original views, reducing visual artifacts. These techniques may be beneficial for complex or occluded scenes, where traditional mesh extraction methods may produce artifacts such as holes, floating geometry, or rough surfaces.

FIG. 2 is a block diagram of a computing system 200 for generating the three-dimensional mesh representation 110. The computing system 200 can be implemented on a server, a desktop or laptop computer, or on multiple computers in a distributed system, as non-limiting examples.

The computing system 200 can include a prompt processor 202. The prompt processor 202 can generate and/or interpret text prompts based on which objects are generated. The text prompt 102 is an example of a text prompt that the prompt processor 202 can generate and/or interpret. The pipeline 100 can use the text prompts generated and/or interpreted by the prompt processor 202 to generate the three-dimensional mesh representation 110. The prompt processor 202 includes a prompt generator 204 and a prompt interpreter 206.

The prompt generator 204 generates text prompts for generation of assets or objects. In some implementations, the prompt generator 204 generates text prompts using a language model. The prompt generator 204 can generate category lists for objects, materials, colors, and themes. The prompt generator 204 can create natural language templates to integrate the category lists. The prompt generator 204 can combine the category lists and the natural language templates to create diverse prompts. The prompt generator 204 can evaluate and/or rank the diverse prompts. The prompt generator 204 can add contextual phrases to the text prompts, such as phrases specifying a background color and object positioning, to improve spatial clarity.

The prompt interpreter 206 interprets the text prompts. In some implementations, the prompt interpreter 206 determines an object that is intended by the text prompt. The prompt interpreter 206 can employ a language model to apply natural language understanding to the text prompt to identify the object described by the text prompt. The prompt interpreter 206 can extract attributes of the object from the text prompt, such as color, material, and/or style.

The computing system 200 can include an image generator 208. The image generator 208 generates a two-dimensional image, such as the two-dimensional image 104, based on a text prompt, such as the text prompt 102. In some implementations, the image generator 208 generates the two-dimensional image by iteratively transforming a first set of intermediate representations of the object described by the text prompt. The image generator 208 can apply a text-to-image diffusion process to generate the two-dimensional image. The first set of intermediate representations may initially comprise noise or random values, and the image generator 208 iteratively refines the intermediate representations to progressively reduce noise and increase fidelity to the object described by the text prompt.

In some implementations, the image generator 208 generates the two-dimensional image by transforming a first representation of the object based on a probability of a first feature being included in the two-dimensional image of the object. The transformation based on the probability can be iterative. The probability of the first feature can be based on the first representation of the object and at least two sample two-dimensional images. The at least two sample two-dimensional images can be a dataset of images used to train the image generator 208. The transformation of the first representation of the object based on the probability can be characterized by a Markov Chain, in which a reverse process progressively refines the first representation from noise toward a target state. The two-dimensional image 104 and the two-dimensional image 306 are examples of a first two-dimensional image of the object.

The image generator 208 includes an isolator 210. The isolator 210 isolates objects in the two-dimensional image to ensure a smooth, homogeneous background for the objects. In some implementations, the isolator 210 applies semantic segmentation to the two-dimensional image to isolate the object from a background. The isolator 210 can add padding around the isolated object to generate an isolated two-dimensional image. The isolator 210 improves the quality and consistency of the two-dimensional image for subsequent generation of the three-dimensional mesh representation.

The computing system 200 includes a view generator 212. The view generator 212 generates multiple two-dimensional views, such as the two-dimensional views 108A, 108B, 108C, 108D, 108E, 108F, based on a two-dimensional image, such as the two-dimensional image 104. The view generator 212 generates the multiple two-dimensional views by iteratively transforming a second set of intermediate representations of the object, such as the set of intermediate representations 106, based on the two-dimensional image and a plurality of camera poses. The multiple two-dimensional views generated by the view generator 212 are geometrically consistent with each other.

In some implementations, the view generator 212 generates the multiple two-dimensional views by transforming the second set of intermediate representations based on the two-dimensional image and a probability of a second feature being included in a second two-dimensional image of the object. Each of the multiple two-dimensional views 108A, 108B, 108C, 108D, 108E, 108F is an example of a second two-dimensional image of the object generated from a different perspective than the first two-dimensional image. The set of intermediate representations 106 is an example of a second representation of the object. The transformation of the second representation can also be characterized by a Markov Chain.

In some implementations, the view generator 212 applies a multi-view diffusion process to generate the multiple two-dimensional views. The multi-view diffusion process is an example of transforming the second set of intermediate representations based on the two-dimensional image and a probability of a second feature being included in a second two-dimensional image of the object. The multi-view diffusion process iteratively refines the second set of intermediate representations to generate high-fidelity views of the object from multiple camera poses. The view generator 212 can apply latent representation encoding, pose-conditioned diffusion, and progressive view synthesis to generate the multiple two-dimensional views.

In some implementations, the probability of the second feature being included in the second two-dimensional image of the object is based on a first three-dimensional representation of the object. The first three-dimensional representation of the object can be a three-dimensional volume constructed from vertices that are projected onto the second two-dimensional images to obtain features. The features from each second two-dimensional image can be extracted and concatenated to form a spatial feature volume. The spatial feature volume enforces a global constraint that all second two-dimensional images are views of the same object, thereby achieving geometrical consistency across the second two-dimensional images.

The view generator 212 includes a viewpoint processor 214. The viewpoint processor 214 determines the camera poses from which the views of the object will be generated. The viewpoint processor 214 can generate a plurality of camera poses representing different viewing angles of the object, such as front, back, sides, top, and bottom views. The viewpoint processor 214 provides the camera poses to the view generator 212 to assist in generation of the multiple two-dimensional views. The camera poses inform the view generator 212 of the positions and orientations from which the object should be depicted in each of the multiple two-dimensional views. The camera poses generated by the viewpoint processor 214 are examples of at least two camera poses, where a first of the at least two camera poses corresponds to the first two-dimensional image and a second of the at least two camera poses corresponds to the second two-dimensional image of the object.

In some implementations, the viewpoint processor 214 selects strategic anchor views using an autoregressive sampling strategy. The viewpoint processor 214 can cluster proximal camera positions to scale to dense viewpoints while maintaining coherence across target viewpoints. The viewpoint processor 214 can determine camera poses that provide comprehensive coverage of the object from multiple angles to improve the accuracy of the subsequent three-dimensional mesh representation.

The computing system 200 includes an object generator 216. The object generator 216 generates the three-dimensional mesh representation, such as the three-dimensional mesh representation 110, based on the multiple two-dimensional views, such as the two-dimensional views 108A, 108B, 108C, 108D, 108E, 108F, and the camera poses. The object generator 216 generates the three-dimensional mesh representation by generating a set of three-dimensional points based on the multiple two-dimensional views and the camera poses. The three-dimensional mesh representation is an example of a three-dimensional representation of the object. The three-dimensional mesh representation can be considered a second three-dimensional representation of the object.

In some implementations, the object generator 216 applies a Neural Radiance Field (NeRF) transformation to the multiple two-dimensional views and the camera poses. The NeRF transformation learns to predict, for any point in three-dimensional space, how dense that point is (whether the point is part of the object or empty space) and what color that point would appear when viewed from any direction. By querying many points throughout the space around the object, the object generator 216 builds up a volumetric representation. The volumetric representation can be considered a three-dimensional cloud of points with associated density and color values.

In some implementations, the object generator 216 applies enhancements to the NeRF transformation to improve geometric fidelity. The enhancements can include density regularization by applying a logarithmic sparsity loss on the output densities, normal smoothness and orientation losses to improve surface quality, and estimated normal supervision by leveraging a monocular depth estimation model.

After generating the volumetric representation, the object generator 216 extracts the three-dimensional mesh representation from the volumetric representation. In some implementations, the object generator 216 applies a Signed Surface Approximation Network (SSAN) to distill the volumetric representation into a compact mesh format with precise geometry and view-dependent color properties. The three-dimensional mesh representation defines geometry through vertices, edges, and faces, enabling integration into standard computer graphics and simulation pipelines.

The computing system 200 includes a scene processor 218. The scene processor 218 receives a virtual scene, such as a layout of a building or a predefined floor plan. The virtual scene can include architectural elements such as walls, floors, ceilings, windows, and doors. The virtual scene can also include existing objects or furniture that have been previously placed in the scene. The virtual scene can be received and/or stored in various formats suitable for three-dimensional rendering and manipulation.

The scene processor 218 adds objects, which can be in the format of three-dimensional mesh representations, such as the three-dimensional mesh representation 110, to the virtual scene. In some implementations, the scene processor 218 scales the objects to fit appropriately within the virtual scene. The scene processor 218 can position the object at a specified location within the virtual scene. The scene processor 218 can perform asset scaling and placement by importing the three-dimensional mesh representation of the object for intuitive scaling and alignment within the virtual scene. The scene processor 218 can perform scene composition by positioning the three-dimensional mesh representation of the object to achieve realistic spatial arrangements. By adding the three-dimensional mesh representation of the object to the virtual scene, the scene processor 218 enables creation of realistic, editable scenes for applications such as simulation, architectural visualization, interactive media, virtual reality, gaming, and AI-driven simulation. The scene processor 218 can generate synthetic three-dimensional indoor scenes that can be used for training machine learning perception models. In some implementations, the scene processor 218 can replace existing objects in the virtual scene with semantically equivalent objects represented by three-dimensional mesh representations. This enables generation of multiple permutations of the same room with different generated objects, increasing the diversity of synthetic training data.

In some implementations, the scene processor 218 uses a rendering tool to incorporate objects into floor plans. The rendering tool enables the scene processor 218 to import three-dimensional mesh representations, scale and align the three-dimensional mesh representations within the virtual scene, and position the three-dimensional mesh representations to achieve realistic spatial arrangements. The rendering tool can render the virtual scene with the incorporated objects to produce images or video of the synthetic three-dimensional indoor scene. The rendering tool can support creating realistic, editable scenes for applications such as simulation, architectural visualization, and interactive media.

The computing system 200 can include at least one processor 220. The at least one processor 220 can execute instructions, such as instructions stored in at least one memory 222, to cause the computing system 200 to perform any combination of methods, functions, and/or techniques described herein.

The computing system 200 can include at least one memory 222. The at least one memory 222 can include a non-transitory computer-readable storage medium. The at least one memory 222 can store data and instructions thereon that, when executed by at least one processor, such as the processor 220, are configured to cause the computing system 200 to perform any combination of methods, functions, and/or techniques described herein. Accordingly, in any of the implementations described herein (even if not explicitly noted in connection with a particular implementation), software (e.g., processing modules, stored instructions) and/or hardware (e.g., processor, memory devices, etc.) associated with, or included in, the computing system 200 can be configured to perform, alone, or in combination with the computing system 200, any combination of methods, functions, and/or techniques described herein.

The computing system 200 may include at least one input/output 224. The at least one input/output 224 may receive and/or send data, such as from and/or to, a server, and/or may receive input and provide output from and to a user. The input and output functions may be combined into a single node, or may be divided into separate input and output nodes. The input/output 224 can include, for example, a display that presents output such as textual output, a camera, a speaker, a microphone, one or more buttons, a typing interface such as a keyboard, and/or one or more wired or wireless interfaces for communicating with other computing devices

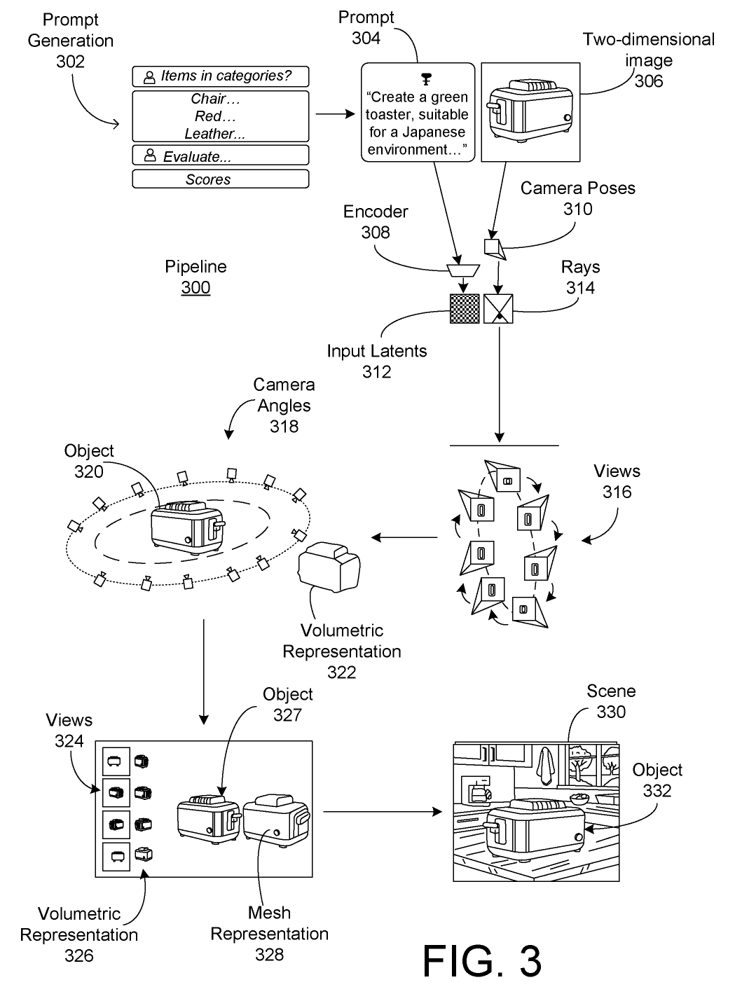

FIG. 3 is another pipeline 300 for generating a three-dimensional mesh representation 328 of an object from a text prompt 304. The pipeline 300 can generate the mesh representation 328 and place an object 332 into a three-dimensional scene 330.

The pipeline 300 includes prompt generation 302. The prompt generation 302 includes generating text prompts, such as a text prompt 304, for generation of three-dimensional objects. The prompt generation 302 can be performed by the prompt generator 204 of the prompt processor 202.

A technical problem with generating high-quality synthetic three-dimensional scenes is generating prompts that will result in objects that can be placed into the synthetic three-dimensional scenes. A technical solution to this technical problem is automated prompt generation. A technical benefit of automated prompt generation is expansion of object diversity in the synthetic data by incorporating domain-specific details. In some implementations, the prompt generation 302 of the pipeline 300 generates precise textual inputs to ensure outputs meet desired specifications, including object type, material, color, and style.

The prompt generation 302 can include contextual precision. Specific contextual phrases can be included to refine the text prompts. Adding phrases such as "in an empty white background" and "in the middle" can improve spatial clarity, preventing issues like object cropping or awkward placements. These contextual phrases ensure that generated assets align with the requirements of the pipeline 300.

The prompt generation 302 can include scalable prompt generation. A procedure for automating the generation of diverse, high-quality text prompts for synthetic room assets can include generating category lists for objects, materials, colors, and/or high-level themes, each with multiple realistic entries. In some implementations, objects can include chairs, tables, and vases. In some implementations, materials can range from wood and metal to fabric and glass. In some implementations, descriptive colors such as blue or metallic gray can further diversify the dataset. The procedure for automating the generation of text prompts can include creating natural language templates to integrate these categories in various sentence structures, avoiding redundancy. Examples of natural language templates include: "Design a [Color] [Material] [Object] inspired by [High-level Theme] aesthetics," or, "Create a [Object] that is both functional and aesthetically pleasing, using [Color] [Material] within a [High-level Theme] setting." The procedure for automating the generation of text prompts can include combining the generated categories and templates to create diverse prompts by permuting the variables. The procedure for automating the generation of text prompts can include evaluating the prompts based on coherence, specificity, and/or creativity, to improve the likelihood that the prompts generate objects are realistic, plausible, and/or visually appealing. The procedure for automating the generation of text prompts can include ranking the prompts based on a score and saving the prompts to provide the prompts to the next step of the pipeline 300, the prompt 304.

The prompt 304 is a text prompt generated by the prompt generation 302. In the example shown in FIG. 3, the prompt 304 is "Create a green toaster, suitable for a Japanese environment..." The prompt 304 describes an object to be generated by the pipeline 300, including attributes such as color, style, and context.

The prompt 304 can be generated by the prompt generation 302 using the scalable prompt generation procedure described above. The prompt generation 302 can combine category lists and natural language templates to create the prompt 304, and can evaluate and rank the prompt 304 based on coherence, specificity, and creativity.

The pipeline 300 uses the prompt 304 to generate a two-dimensional image 306 of the object described by the prompt 304. The two-dimensional image 306 can be generated by iteratively transforming a first set of intermediate representations of the object based on the prompt 304, similar to the generation of the two-dimensional image 104 described with respect to FIG. 1. The two-dimensional image 306 depicts the object described by the prompt 304, such as a green toaster. The two-dimensional image 306 is an example of a first two-dimensional image of the object.

The pipeline 300 can generates the two-dimensional image 306 based on the prompt 304 using a text-to-image generation algorithm. The text-to-image generation can build upon the prompt engineering of the prompt generation 302 by utilizing text-to-image diffusion models to generate high-quality two-dimensional images for three-dimensional reconstruction pipelines. Text prompts allow for scalable, adaptable, and diverse synthetic data generation, reducing reliance on real-world captures while offering fine-grained control over content.

In some implementations, the pipeline 300 generates the two-dimensional image 306 by transforming a first representation of the object based on a probability of a first feature being included in the two-dimensional image 306 of the object. The probability of the first feature can be based on the first representation of the object and at least two sample two-dimensional images. The at least two sample two-dimensional images can be a dataset of images used to train a model that generates the two-dimensional image 306. The transformation of the first representation of the object based on the probability can be characterized by a Markov Chain, in which a reverse process progressively refines the first representation from noise toward a target state.

In some implementations, the pipeline 300 integrates a semantic segmentation to isolate objects in the two-dimensional image 306 and ensure smooth, homogeneous backgrounds. The semantic segmentation can add padding around the object in the two-dimensional image 306. This design choice addresses common issues in text-to-image models when the goal is to generate single objects, where extraneous elements or cluttered backgrounds can interfere with subsequent processing. Segmentation improves the quality and consistency of inputs for three-dimensional isolated object reconstruction.

The pipeline 300 includes an encoder 308. The encoder 308 receives the two-dimensional image 306 and camera poses 310 as inputs. The encoder 308 generates input latents 312 from the two-dimensional image 306.

The encoder 308 performs latent representation encoding by applying a variational auto-encoder (VAE) to transform the two-dimensional image 306 into a latent space that includes input latents 312. The input latents 312 are compressed, encoded versions of the two-dimensional image 306 that capture spatial and semantic features of the object. The input latents 312 capture information about the object in a more compact form than the full two-dimensional image 306.

The encoder 308 also generates rays 314 based on the camera poses 310. The rays 314 represent the camera positions and orientations from which the views 316 will be generated. In some implementations, the rays 314 are a relative raymap representation of the camera's position and orientation that is concatenated with the input latents 312.

The pipeline 300 uses the input latents 312 and the rays 314 to generate the views 316 of the object from multiple camera angles 318. The camera angles 318 can also be considered camera poses. The pipeline 300 generates the views 316 by iteratively transforming the input latents 312 based on the rays 314 and the camera poses 310. The views 316 are multiple two-dimensional views of the object that are geometrically consistent with each other. Each of the views 316 is an example of a second two-dimensional image of the object generated from a different perspective than the first two-dimensional image (as well as from a different perspective than the other views 316).

In some implementations, the pipeline 300 generates the views 316 by transforming a second representation of the object based on the first two-dimensional image 306 and a probability of a second feature being included in a second two-dimensional image of the object. The views 316 are examples of the second two-dimensional image of the object. The transformation of the second representation can also be characterized by a Markov Chain.

In some implementations, the transformation of the second representation of the object is further based on at least two camera poses. A first of the at least two camera poses can correspond to the first two-dimensional image 104 and a second of the at least two camera poses can correspond to the second two-dimensional image of the object. The camera angles 318 are examples of camera poses.

The views 316 depict the object, of which the two-dimensional image 306 is a representation, from multiple camera angles 318, providing geometrically consistent perspectives of the object. The pipeline 300 can build upon a multi-view latent diffusion model approach to generate globally consistent views. The multi-view diffusion process generates consistent two-dimensional projections from single-image inputs and camera poses. An autoregressive sampling of the views can ensure geometrical consistency across views, which is beneficial for accurate three-dimensional reconstruction.

In some implementations, the probability of the second feature being included in the second two-dimensional image of the object is based on a first three-dimensional representation of the object. The first three-dimensional representation of the object can be a three-dimensional volume constructed from vertices that are projected onto the second two-dimensional images to obtain features. The features from each second two-dimensional image can be extracted and concatenated to form a spatial feature volume. The spatial feature volume enforces a global constraint that the second two-dimensional images are views of the same object, thereby achieving geometrical consistency across the second two-dimensional images.

The generation of the views 316 can include latent representation encoding performed by the encoder 308, applying a variational auto-encoder (VAE) to transform the two-dimensional image 306 into a latent space, capturing spatial and semantic features used for reasoning about unseen views. The generation of the views 316 can include pose-conditioned diffusion to ensure that the model is conditioned on camera poses corresponding to observed and target viewpoints, which can be achieved by concatenating a relative raymap representation of the camera's position and orientation with the latent embeddings. The generation of the views 316 can include progressive view synthesis, where the pipeline 300 generates multiple target views by iteratively refining the intermediate representations into high-fidelity projections, thereby ensuring spatial consistency across synthesized outputs.

Consistency across synthesized views improves downstream three-dimensional reconstruction tasks, such as generation of the mesh representation 328. The multi-view diffusion process can incorporate three-dimensional self-attention layers and binary masks to indicate observed inputs during training, addressing the inherent challenges of sparse input scenarios. Strategic anchor views can be selected using an autoregressive sampling strategy, enabling efficient reasoning from limited data. To scale to dense viewpoints, the pipeline 300 can cluster proximal camera positions and leverage anchor views to maintain coherence across target viewpoints.

The pipeline 300 generates the object 320 from the views 316 and the camera angles 318. The object 320 is a three-dimensional representation of the object depicted in the views 316. The pipeline 300 applies a Neural Radiance Field (NeRF) transformation to the views 316 and the camera angles 318 to generate the object 320. The object 320 is an example of a first three-dimensional representation of the object.

NeRFs transform multi-view two-dimensional projections into detailed three-dimensional scene representations. NeRFs are neural network-based models that generate high-quality three-dimensional scenes from two-dimensional images by learning to represent volumetric density and view-dependent color at any three-dimensional point. The NeRF learns to predict, for any point in three-dimensional space, how dense that point is (whether the point is part of the object or empty space) and what color that point would appear when viewed from any direction.

The pipeline 300 generates the volumetric representation 322 by querying many points throughout the space around the object 320. The volumetric representation 322 is a three-dimensional cloud of points with associated density and color values. The volumetric representation 322 captures the shape and appearance of the object from the information contained in the views 316. The volumetric representation 322 is an example of a first three-dimensional representation of the object.

In some implementations, the pipeline 300 applies enhancements to the NeRF transformation to improve geometrical consistency. The enhancements can include density regularization for better geometrical consistency to a single object by including a logarithmic sparsity loss on the output densities. The enhancements can include input segmentation of all the input views for background consistency. The enhancements can include normal smoothing to address orientation losses. The enhancements can include estimated normal supervision by leveraging a monocular depth estimation model, which uses the estimated depth to compute gradients and use them as view-corresponding normals to regularize the geometry of the resulting asset.

A technical problem with NeRFs is that NeRFs are inherently volumetric, making direct integration into standard graphics pipelines challenging. A technical solution to this technical problem is NeRFMeshing, which extracts geometrically accurate three-dimensional meshes from NeRFs, enabling their integration into standard computer graphics and simulation pipelines. A technical benefit of NeRFMeshing is that it overcomes traditional NeRF limitations in geometry accuracy and compatibility with graphics workflows.

The pipeline 300 can generate the views 316 and the object 320 efficiently. In some implementations, the pipeline 300 uses multiple graphics processing units (GPUs) to sample the multi-view diffusion model and to train and evaluate the NeRF and NeRFMeshing architectures. The pipeline 300 can generate a three-dimensional mesh representation in a reduced amount of time compared to prior approaches. The pipeline 300 allows for flexibility of generations based on a prompt, as some steps may not be trained on specific three-dimensional datasets, unlike prior models trained end-to-end with three-dimensional-geometry-informed supervision that can struggle to generate out-of-domain when the input prompts are diverse.

The pipeline 300 generates views 324 from the object 320 and the volumetric representation 322. The views 324 are additional rendered perspectives of the object 320 generated from the volumetric representation 322. The views 324 can be used to refine the three-dimensional representation of the object.

The pipeline 300 generates the volumetric representation 326 based on the views 324. The volumetric representation 326 is a refined three-dimensional cloud of points with associated density and color values. The object 327 is a three-dimensional representation of the object based on the volumetric representation 326.

The pipeline 300 generates the mesh representation 328 from the volumetric representation 326. The pipeline 300 can apply NeRFMeshing to extract geometrically accurate three-dimensional meshes from the volumetric representation 326, enabling integration into standard computer graphics and simulation pipelines. By applying a Signed Surface Approximation Network (SSAN), the volumetric representation 326 is distilled into a compact mesh format with precise geometry and view-dependent color properties. This process facilitates real-time rendering and supports physics-based simulations. The three-dimensional representation of the object generated by the pipeline 300 is based on the first two-dimensional image 306 and the second two-dimensional image (e.g., views 316).The mesh representation 328 is an example of a second three-dimensional representation of the object.

In some implementations, the pipeline 300 applies additional SSIM and/or LPIPS supervision for improved rendering after the mesh extraction. SSIM (Structural Similarity Index Measure) is a metric used to measure the similarity between two images. SSIM evaluates the perceived quality of an image by comparing structural information, luminance, and/or contrast between a generated image and a reference image. In the context of the pipeline 300, SSIM supervision can be applied during or after mesh extraction to ensure that rendered views of the mesh representation 328 are structurally similar to the original views 324. SSIM helps preserve the visual structure and details of the object during the mesh extraction process. LPIPS (Learned Perceptual Image Patch Similarity) is a perceptual similarity metric that applies deep neural network features to measure the perceptual difference between two images. Unlike pixel-level metrics, LPIPS evaluates how similar two images appear to human perception by comparing features extracted from a neural network. In the context of the pipeline 300, LPIPS supervision can be applied to ensure that the mesh representation 328 produces rendered views that are perceptually similar to the target views, maintaining visual fidelity and semantic consistency. Together, SSIM and LPIPS supervision can improve the quality of the mesh representation 328 by ensuring that rendered views from the extracted mesh are both structurally accurate and perceptually similar to the original views used to generate the mesh.

The mesh representation 328 is a three-dimensional mesh representation of the object that defines geometry through vertices, edges, and faces. The mesh representation 328 can be integrated into standard computer graphics and simulation pipelines, such as the scene 330.

The scene 330 is a three-dimensional scene into which the mesh representation 328 can be integrated. In the example shown in FIG. 3, the scene 330 is a kitchen that includes architectural elements such as walls, floors, ceilings, and a countertop. The scene 330 can be a pre-defined floor plan or a virtual scene.

The object 332 is based on the mesh representation 328. The object 332 is a three-dimensional representation of the object that has been placed into the scene 330. In the example shown in FIG. 3, the object 332 is a green toaster that has been generated from the prompt 304 through the pipeline 300.

The pipeline 300 can place the object 332 on the countertop of the scene 330. The pipeline 300 can scale the object 332 to fit appropriately within the scene 330 and position the object 332 at a specified location, such as on the countertop. By placing the object 332 into the scene 330, the pipeline 300 can generate a synthetic three-dimensional indoor scene that can be used for training machine learning perception models.

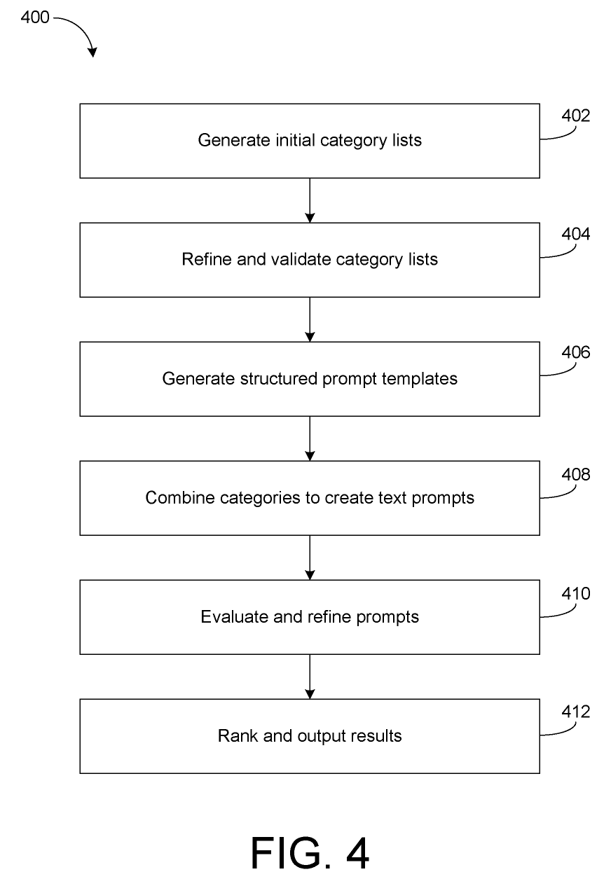

FIG. 4 is a flowchart of a method 400 for generating text prompts for synthetic three-dimensional object generation. The method 400 can be performed by the prompt generator 204 of the prompt processor 202, or as a feature of the prompt generation 302 of the pipeline 300.

The method 400 includes generating initial category lists (402). Generating the initial category lists (402) includes prompting a language model to create multiple (such as ten to twenty) diverse and realistic items for each of multiple categories. The categories can include objects, materials, colors, and high-level themes, as non-limiting examples. The results can be organized into a structured table. In some implementations, objects can include chairs, tables, and vases. In some implementations, materials can range from wood and metal to fabric and glass. In some implementations, descriptive colors such as blue or metallic gray can further diversify the dataset.

The method 400 includes refining and validating category lists (404). Refining and validating the category lists (404) includes removing duplicates and nonsensical combinations from raw lists. This ensures that the category lists contain realistic and plausible entries for subsequent prompt generation.

The method 400 includes generating structured prompt templates (406). Generating the structured prompt templates (406) includes defining template variables, such as object, color, material, and high-level theme, as non-limiting examples. Generating the structured prompt templates (406) includes prompting the language model to generate natural language templates with diverse sentence structures. Examples of natural language templates include, "Design a [Color] [Material] [Object] inspired by [High-level Theme] aesthetics," or, "Create a [Object] that is both functional and aesthetically pleasing, using [Color] [Material] within a [High-level Theme] setting."

The method 400 includes combining categories to create text prompts (408). Combining the categories to create text prompts (408) includes randomly sampling combinations of template variables, such as object, material, color, and a high-level theme. Combining the categories to create text prompts (408) includes filling variables or placeholders in structured templates with sampled values. For example, the template variables object, material, color, and high-level theme could be filled with toaster, stainless steel, green, and Japanese environment, respectively. By permuting samples values for the variables across the templates, the method 400 can generate a large number of diverse text prompts.

The method 400 includes evaluating and refining prompts (410). Evaluating and refining the prompts (410) includes feeding generated prompts the prompts generated by combining categories to create text prompts (408) into the language model for evaluation based on factors such as coherence, specificity, and/or creativity. Coherence can include whether the object-material-color combination makes sense. Specificity can include whether the object and setting are clearly described. Creativity can include whether the prompt results in visually compelling designs. Evaluating and refining the prompts (410) includes assigning a realism score to each prompt. The realism score can be determined by a language model.

The method 400 includes ranking and outputting results (412). Ranking and outputting the results (412) includes sorting prompts by realism scores and outputting the resulting list. The output can be a final dataset of filtered and ranked prompts ready for three-dimensional asset generation. In some implementations, the final dataset includes a predetermined number of the prompts with highest scores. The ranked prompts can be provided to subsequent steps of the pipeline 100 or the pipeline 300 for generation of two-dimensional images and three-dimensional mesh representations.

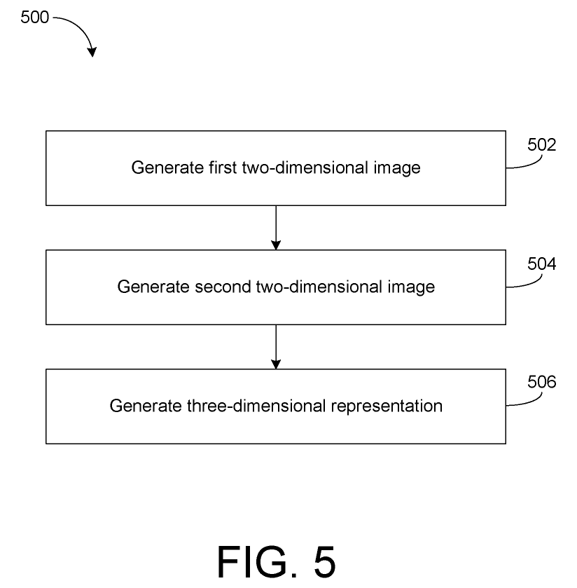

FIG. 5 is a flowchart of a computer-implemented method 500 performed by the computing system 200. The computer-implemented method 500 includes Generating a first two-dimensional image (502). Generating the first two-dimensional image (502) can include generating a first two-dimensional image of an object based on a prompt describing the object; and a transformation of a first representation of the object based on a probability of a first feature being included in the first two-dimensional image of the object, the probability of the first feature being based on the first representation of the object and at least two sample two-dimensional images. The computer-implemented method 500 can include generating a second two-dimensional image (504). Generating the second two-dimensional image (504) can include generating a second two-dimensional image of the object from a different perspective than the first two-dimensional image of the object by transforming a second representation of the object based on the first two-dimensional image and a probability of a second feature being included in the second two-dimensional image of the object. The computer-implemented method 500 can include generating a three-dimensional representation (506). Generating the three-dimensional representation (506) can include generating a three-dimensional representation of the object based on the first two-dimensional image of the object and the second two-dimensional image of the object.

In some implementations, the three-dimensional representation of the object is a second three-dimensional representation of the object, and the probability of the second feature being included in the second two-dimensional image of the object is based on a first three-dimensional representation of the object.

In some implementations, transforming the second representation of the object is based on the first two-dimensional image, the probability of the second feature being included in the second two-dimensional image of the object, and at least two camera poses, a first of the at least two camera poses corresponding to the first two-dimensional image of the object and a second of the at least two camera poses corresponding to the second two-dimensional image of the object.

In some implementations, the computer-implemented method 500 further includes performing semantic segmentation on the first two-dimensional image of the object to generate an isolated two-dimensional image of the object, the isolated two-dimensional image of the object being isolated from a background of the first two-dimensional image of the object. Generating the second two-dimensional image of the object includes generating the second two-dimensional image based on the isolated two-dimensional image of the object.

In some implementations, the computer-implemented method 500 further includes generating the prompt, the prompt including a contextual phrase specifying a position of the object.

In some implementations, transforming the second representation of the object includes applying a variational auto-encoder to the first two-dimensional image.

In some implementations, the computer-implemented method 500 further includes adding the three-dimensional representation of the object to a three-dimensional scene.

In some implementations, the three-dimensional representation of the object is a three-dimensional mesh representation of the object.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method comprising:
generating a first two-dimensional image of an object based on:
a prompt describing the object; and
a transformation of a first representation of the object based on a probability of a first feature being included in the first two-dimensional image of the object, the probability of the first feature being based on the first representation of the object and at least two sample two-dimensional images;
generating a second two-dimensional image of the object from a different perspective than the first two-dimensional image of the object by transforming a second representation of the object based on the first two-dimensional image and a probability of a second feature being included in the second two-dimensional image of the object; and
generating a three-dimensional representation of the object based on the first two-dimensional image of the object and the second two-dimensional image of the object.

2. The computer-implemented method of claim 1, wherein:
the three-dimensional representation of the object is a second three-dimensional representation of the object, and
the probability of the second feature being included in the second two-dimensional image of the object is based on a first three-dimensional representation of the object.

3. The computer-implemented method of claim 1, wherein transforming the second representation of the object is based on:
the first two-dimensional image,
the probability of the second feature being included in the second two-dimensional image of the object, and
at least two camera poses, a first of the at least two camera poses corresponding to the first two-dimensional image of the object and a second of the at least two camera poses corresponding to the second two-dimensional image of the object.

4. The computer-implemented method of claim 1, further comprising:
performing semantic segmentation on the first two-dimensional image of the object to generate an isolated two-dimensional image of the object, the isolated two-dimensional image of the object being isolated from a background of the first two-dimensional image of the object,
wherein generating the second two-dimensional image of the object includes generating the second two-dimensional image based on the isolated two-dimensional image of the object.

5. The computer-implemented method of claim 1, further comprising generating the prompt, the prompt including a contextual phrase specifying a position of the object.

6. The computer-implemented method of claim 1, wherein transforming the second representation of the object includes applying a variational auto-encoder to the first two-dimensional image.

7. The computer-implemented method of claim 1, further comprising adding the three-dimensional representation of the object to a three-dimensional scene.

8. The computer-implemented method of claim 1, wherein the three-dimensional representation of the object is a three-dimensional mesh representation of the object.

9. A non-transitory computer-readable storage medium comprising instructions stored thereon that, when executed by at least one processor, are configured to cause a computing system to:
generate a first two-dimensional image of an object based on:
a prompt describing the object; and
a transformation of a first representation of the object based on a probability of a first feature being included in the first two-dimensional image of the object, the probability of the first feature being based on the first representation of the object and at least two sample two-dimensional images;
generate a second two-dimensional image of the object from a different perspective than the first two-dimensional image of the object by transforming a second representation of the object based on the first two-dimensional image and a probability of a second feature being included in the second two-dimensional image of the object; and
generate a three-dimensional representation of the object based on the first two-dimensional image of the object and the second two-dimensional image of the object.

10. The non-transitory computer-readable storage medium of claim 9, wherein:
the three-dimensional representation of the object is a second three-dimensional representation of the object, and
the probability of the second feature being included in the second two-dimensional image of the object is based on a first three-dimensional representation of the object.

11. The non-transitory computer-readable storage medium of claim 9, wherein transforming the second representation of the object is based on:
the first two-dimensional image,
the probability of the second feature being included in the second two-dimensional image of the object, and
at least two camera poses, a first of the at least two camera poses corresponding to the first two-dimensional image of the object and a second of the at least two camera poses corresponding to the second two-dimensional image of the object.

12. The non-transitory computer-readable storage medium of claim 9, wherein the instructions are further configured to cause the computing system to:
performing semantic segmentation on the first two-dimensional image of the object to generate an isolated two-dimensional image of the object, the isolated two-dimensional image of the object being isolated from a background of the first two-dimensional image of the object,
wherein generating the second two-dimensional image of the object includes generating the second two-dimensional image based on the isolated two-dimensional image of the object.

13. The non-transitory computer-readable storage medium of claim 9, wherein the instructions are further configured to cause the computing system to generate the prompt, the prompt including a contextual phrase specifying a position of the object.

14. The non-transitory computer-readable storage medium of claim 9, wherein transforming the second representation of the object includes applying a variational auto-encoder to the first two-dimensional image.

15. A computing system comprising:
at least one processor; and
a non-transitory computer-readable storage medium comprising instructions stored thereon that, when executed by the at least one processor, are configured to cause the computing system to:
generate a first two-dimensional image of an object based on:
a prompt describing the object; and
a transformation of a first representation of the object based on a probability of a first feature being included in the first two-dimensional image of the object, the probability of the first feature being based on the first representation of the object and at least two sample two-dimensional images;
generate a second two-dimensional image of the object from a different perspective than the first two-dimensional image of the object by transforming a second representation of the object based on the first two-dimensional image and a probability of a second feature being included in the second two-dimensional image of the object; and
generate a three-dimensional representation of the object based on the first two-dimensional image of the object and the second two-dimensional image of the object.

16. The computing system of claim 15, wherein:
the three-dimensional representation of the object is a second three-dimensional representation of the object, and
the probability of the second feature being included in the second two-dimensional image of the object is based on a first three-dimensional representation of the object.

17. The computing system of claim 15, wherein transforming the second representation of the object is based on:
the first two-dimensional image,
the probability of the second feature being included in the second two-dimensional image of the object, and
at least two camera poses, a first of the at least two camera poses corresponding to the first two-dimensional image of the object and a second of the at least two camera poses corresponding to the second two-dimensional image of the object.

18. The computing system of claim 15, wherein the instructions are further configured to cause the computing system to:
performing semantic segmentation on the first two-dimensional image of the object to generate an isolated two-dimensional image of the object, the isolated two-dimensional image of the object being isolated from a background of the first two-dimensional image of the object,
wherein generating the second two-dimensional image of the object includes generating the second two-dimensional image based on the isolated two-dimensional image of the object.

19. The computing system of claim 15, wherein the instructions are further configured to cause the computing system to generate the prompt, the prompt including a contextual phrase specifying a position of the object.

20. The computing system of claim 15, wherein transforming the second representation of the object includes applying a variational auto-encoder to the first two-dimensional image.
